(19) United States
(12) Patent Application Publication
(10) Pub. No.: US 2014/0244237 A1
(43) Pub. Date: Aug. 28, 2014

(54) GLOBAL PRODUCT-SURVEY

(71) Applicant: INTUIT INC., Mountain View, CA (US)

(72) Inventors: Vijayan Srinivasan, Namakkal (IN); Venkata Gopinath Bodagala, Kadapa (IN); Rama Palaniappan, Chennai (IN)

(73) Assignee: INTUIT INC., Mountain View, CA (US)

(21) Appl. No.: 13/850,629

(22) Filed: Mar. 26, 2013

(30) Foreign Application Priority Data
Feb. 28, 2013 (IN) 234/KOL/2013

(51) Int. Cl. G06F 17/28; G06Q 30/02

(52) U.S. Cl. CPC G06F 17/289; G06Q 30/0203
USPC 704/2

(57) ABSTRACT

During a survey technique, a product survey in an original language is translated into a target language, and any errors in the translation are identified and corrected. Words in the translation that do not translate well or clearly may be reverted back to the original language based on transliteration instructions. This may allow customers to answer the translated product survey in the target language using a user interface (such as a keyboard) based on the original language. After receiving answers from the users to questions in the translated product survey, the answers may be analyzed to determine results of the product survey in the target language. Then, the results may be translated back into the original language. After translation into the original language, the results across multiple target languages can be consolidated and presented.

### RELATED APPLICATION

This application claims priority to India Patent Application No. 234/KOL/2013, filed on 28 Feb. 2013, the contents of which are herein incorporated by reference in their entirety for all purposes.

### BACKGROUND

The present disclosure relates to a technique for conducting surveys. In particular, the present disclosure relates to a technique for conducting a survey created in an original language and targeted for one or more additional languages.

Many companies conduct surveys to obtain feedback about products from customers. However, for companies with a global presence, this can be challenging. In particular, a product manager may be in a different country than their customers, and thus may speak a different language than their customers. In this case, using existing approaches, separate surveys need to be created for each of the languages. Consolidating the results of these separate surveys back into the language of the product manager is often complicated and time-consuming.

### SUMMARY

The disclosed embodiments relate to a computer system that conducts a product survey based on information provided by a product manager. During operation, the computer system generates the product survey in an original language. Then, the computer system translates the product survey into a target language, and identifies and corrects errors in the translated product survey. Moreover, the computer system provides the translated product survey to multiple users of the product, and receives answers from the users to questions in the translated product survey. Next, the computer system analyzes the answers to determine results of the product survey in the target language, and translates the results into the original language. Furthermore, the computer system presents the translated results.

In some embodiments, the computer system optionally receives instructions that specify the product survey in the original language, where generating the product survey is based on the instructions. For example, the product manager may specify the questions in the product survey. Additionally, the computer system may optionally receive a selection that specifies the target language, where translating the product survey is based on the selection. For example, the selection may be one of a set of predefined languages.

Note that translating the product survey and/or translating the results involve a machine-translation technique.

Moreover, the errors may be identified based on syntax and lexicography of the original language and the target language. Additionally, identifying the errors may involve receiving information identifying the errors. For example, the computer system may optionally receive the information from a user. Therefore, the errors may be identified by the computer system and/or the errors may be specified manually.

Furthermore, analyzing the answers may involve aggregating the answers of the users.

In some embodiments, after identifying and correcting the errors, the computer system optionally receives a transliteration instruction specifying a mapping of symbols in the original language to symbols in the target language.

Moreover, the transliteration instruction may facilitate the users in providing the answers in the target language using a user interface based on the original language.

Additionally, after translating the results, the computer system may optionally identify and correct errors in the translated results.

Another embodiment provides a method that includes at least some of the operations performed by the computer system.

Another embodiment provides a computer-program product for use with the computer system. This computer-program product includes instructions for at least some of the operations performed by the computer system.

### BRIEF DESCRIPTION OF THE FIGURES

FIG. 1 is a flow chart illustrating a method for conducting a product survey in accordance with an embodiment of the present disclosure.

FIG. 2 is a flow chart illustrating the method of FIG. 1 in accordance with an embodiment of the present disclosure.

FIG. 3 is a drawing of a user interface for specifying a product survey in accordance with an embodiment of the present disclosure.

FIG. 4 is a drawing of a user interface for providing a transliteration instruction in accordance with an embodiment of the present disclosure.

FIG. 5 is a block diagram illustrating a system that performs the method of FIGS. 1 and 2 in accordance with an embodiment of the present disclosure.

FIG. 6 is a block diagram illustrating a computer system that performs the method of FIGS. 1 and 2 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

Embodiments of a computer system, a technique for conducting a product survey, and a computer-program product (e.g., software) for use with the computer system are described. During this survey technique, a product survey in an original language is translated into a target language, and any errors in the translation are identified and corrected. Words in the translation that do not translate well or clearly may be reverted back to the original language based on transliteration instructions. This may allow customers to answer the translated product survey in the target language using a user interface (such as a keyboard) based on the original language. After receiving answers from the users to questions in the translated product survey, the answers may be analyzed to determine results of the product survey in the target language. Then, the results may be translated back into the original language.

By allowing the product survey to be generated and the results to be reviewed in the original language, while the translated product survey is conducted in the target language, the survey technique may facilitate improved understanding of customer needs. In particular, it may be easier for companies that have a global presence to obtain feedback from their customers, and to adapt their products based on the product-survey results in the target language, thereby enhancing sales and customer loyalty. This capability may allow these companies to provide a common product (and, in the case of a software product, a common product with a common codebase) to multiple countries having different languages, thereby reducing costs and increasing profitability.

In the discussion that follows, a user may include: an individual or a person (for example, an existing customer, a new customer, a service provider, a vendor, a contractor, etc.), an organization, a business and/or a government agency. Furthermore, a ‘business’ or ‘company’ should be understood to include: for-profit corporations, non-profit corporations, organizations, groups of individuals, sole proprietorships, government agencies, partnerships, etc.

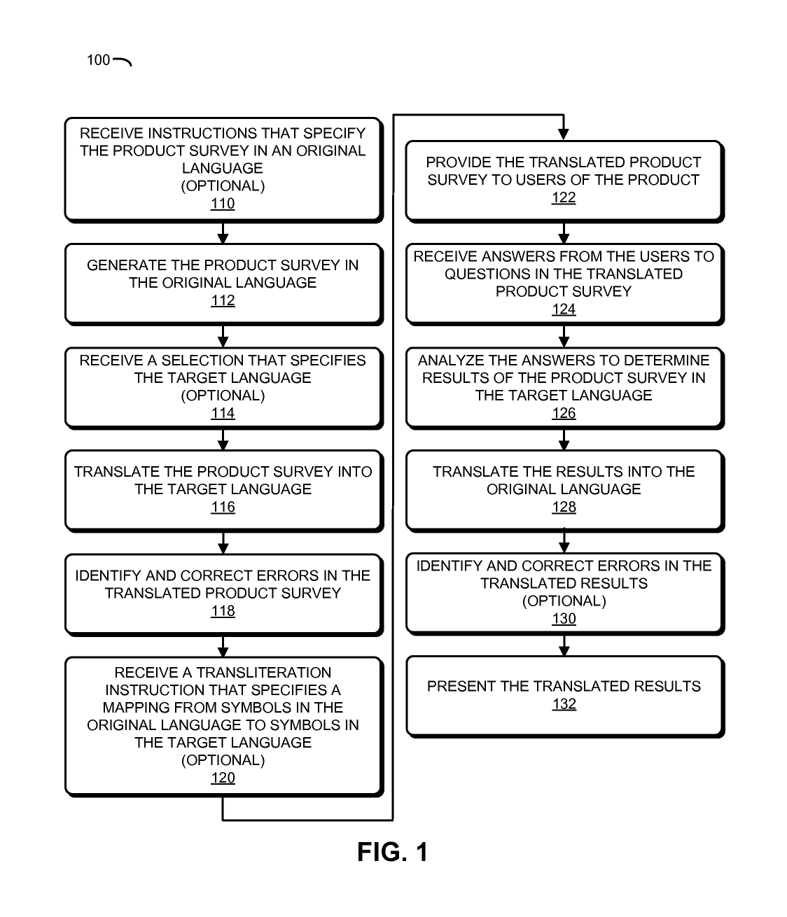

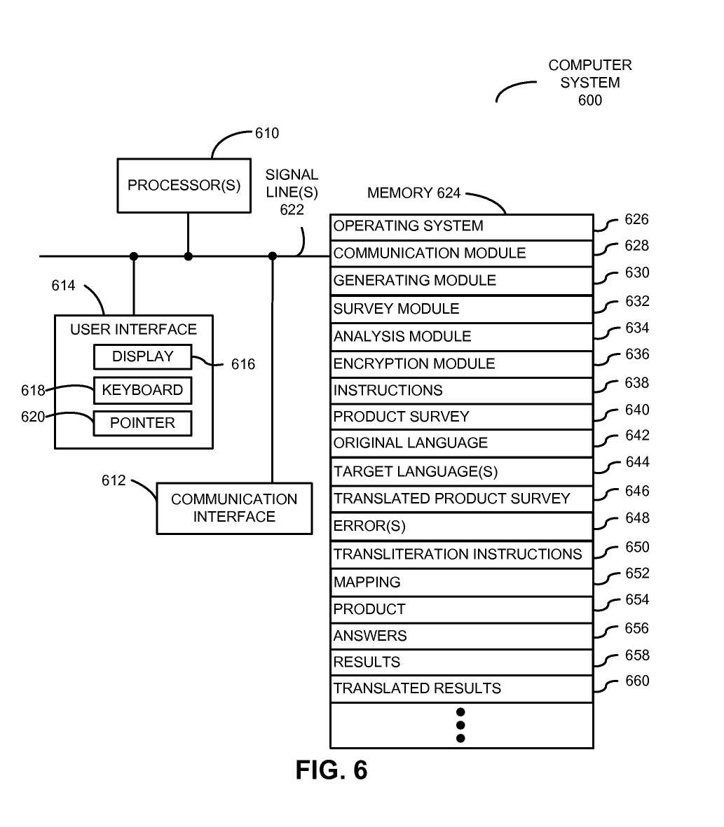

We now describe embodiments of the survey technique. FIG. 1 presents a flow chart illustrating a method 100 for conducting a product survey, which may be performed by a computer system (such as computer system 600 in FIG. 6). During operation, the computer system generates the product survey (i.e., a survey about or related to a product provided by a company or an organization) in an original language (operation 112). For example, the product survey may be generated based on instructions from a user of the computer system, such as a product manager of the product. Therefore, in some embodiments, the computer system optionally receives instructions that specify the product survey in the original language (operation 110).

Then, the computer system translates the product survey into a target language (operation 116). For example, the user may select the target language (such as from a set of predefined languages), and translating the product survey may be based on the selection. Therefore, the computer system may optionally receive the selection that specifies the target language (operation 114). Moreover, translating the product survey may involve a machine-translation technique. In some embodiments, the generated product survey may be shared with multiple additional users inside or outside of an organization (such as a company), which may allow these users to assist in translating the product survey into one or more target languages.

Furthermore, the computer system identifies and corrects errors in the translated product survey (operation 118). The errors may be identified based on syntax and lexicography of the original language and the target language. Alternatively or additionally, identifying the errors may involve receiving information identifying the errors. For example, the computer system may optionally receive the information from a user. Therefore, the errors may be identified by the computer system (i.e., in an automated fashion) and/or the errors may be specified manually.

In some embodiments, after identifying and correcting the errors (operation 118), the computer system optionally receives a transliteration instruction specifying a mapping of symbols (or characters) in the original language to symbols in the target language (operation 120). This transliteration instruction may facilitate multiple users of the product in providing the answers in the target language using a user interface (such as a keyboard, a keypad and/or a touchscreen) based on the original language.

Next, the computer system provides the translated product survey to the users of the product (operation 122), and receives answers from the users to questions in the translated product survey (operation 124).

Additionally, the computer system analyzes the answers to determine results of the product survey in the target language (operation 126), and translates the results into the original language (operation 128). Note that analyzing the answers may involve aggregating the answers of the users and/or translating the results may involve the machine-translation technique. In some embodiments, after translating the results (operation 128), the computer system may optionally identify and correct errors in the translated results (operation 130).

Then, the computer system presents the translated results (operation 132). The presented results may include consolidated results across multiple target languages.

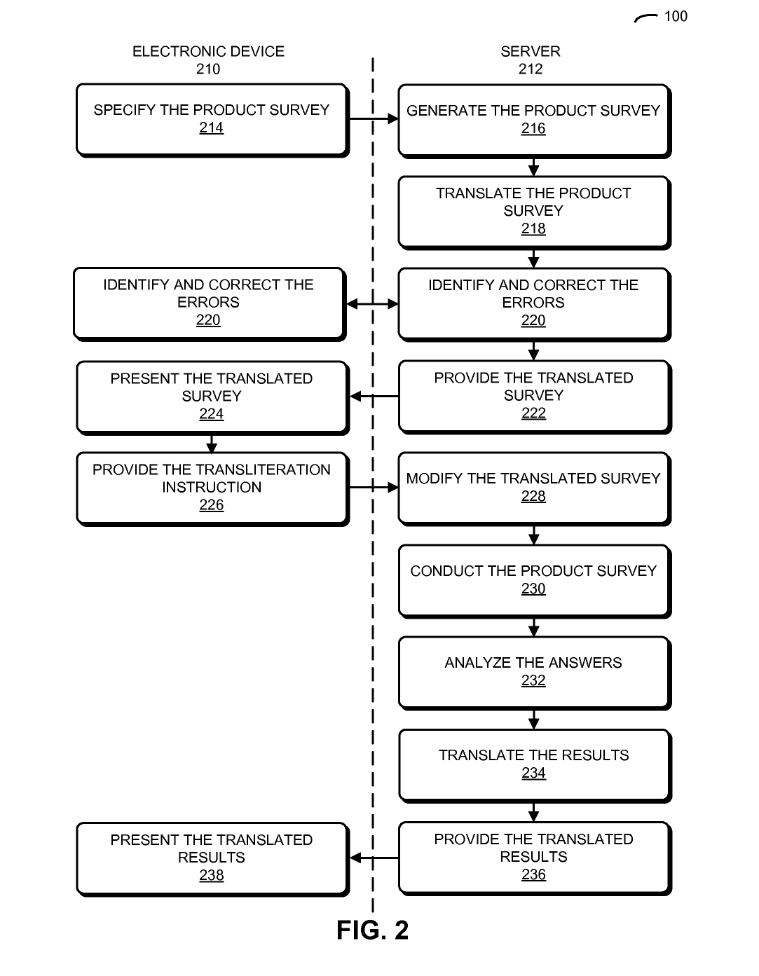

In an exemplary embodiment, the survey technique is implemented using electronic devices (such as a computer or a portable electronic device, e.g., a cellular telephone), and at least one server, which communicate through a network, such as a cellular-telephone network and/or the Internet (e.g., using a client-server architecture). This is illustrated in FIG. 2, which presents a flow chart illustrating method 100 (FIG. 1).

During the method, a user (such as a product manager) of electronic device 210 may specify the product survey (operation 214) in the original language. In response to receiving these instructions, server 212 may generate the product survey (operation 216).

Then, server 212 may translate the product survey (operation 218) into one or more target languages and, if there are any errors, server 212 may identify and correct the errors (operation 220) in the translated product survey. In some embodiments, identifying and correcting the errors (operation 220) is performed, in part or completely, by the user. Thus, operation 220 may be communicated to server 212 by electronic device 210.

Next, server 212 may provide (operation 222) and electronic device 210 may present (operation 224) the translated product survey to the user. In response, the user may provide the transliteration instruction (operation 226) specifying the mapping of symbols in the original language to symbols in the target language. After receiving the transliteration instruction, server 212 may modify the translated product survey (operation 228).

Moreover, server 212 may conduct the product survey (operation 230). This may involve providing the translated product survey to additional electronic devices (not shown) of users of the product, and receiving the answers from the additional electronic devices to questions in the translated product survey.

Server 212 may analyze the answers (operation 232) to determine the results, and may translate the results (operation 234) into the original language. Then, server 212 may provide (operation 236) and electronic device 210 may present (operation 238) the translated results.

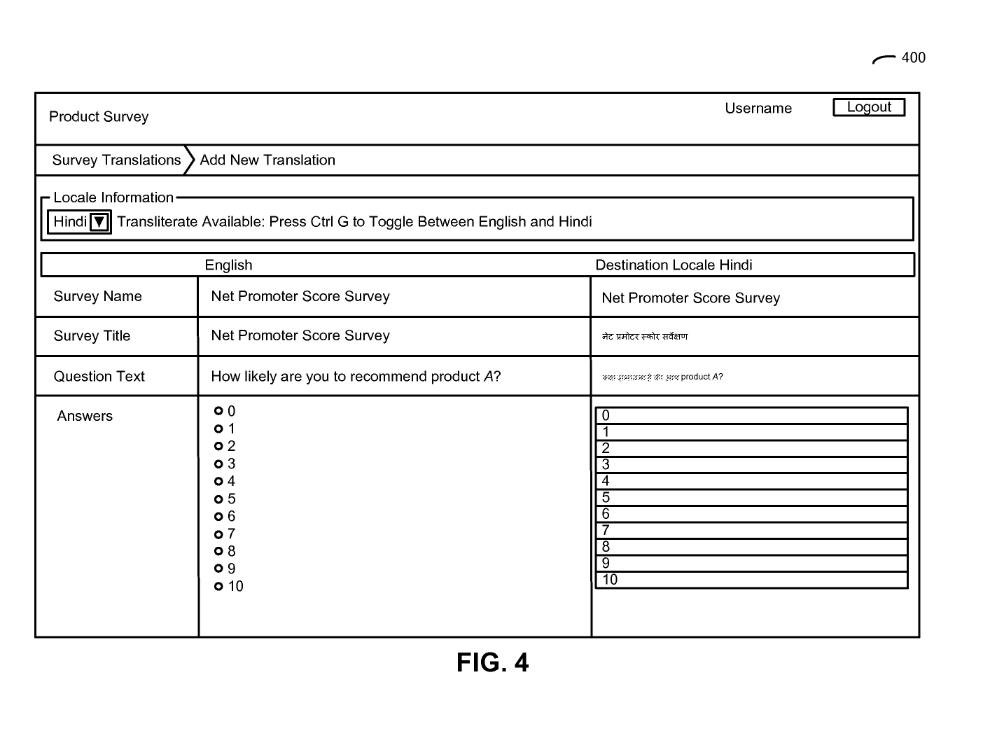

In some embodiments of method 100 (FIGS. 1 and 2), there may be additional or fewer operations. Moreover, the order of the operations may be changed, and/or two or more operations may be combined into a single operation. For example, analyzing the answers (operation 126) and translating the results (operation 128) may be combined in FIG. 1. Furthermore, translating the product survey into a target language (operation 116) and receiving the transliteration instruction (operation 120) may be combined in FIG. 1. For example, these operations may be performed using a common user interface, as described further below with reference to FIG. 4.

In an exemplary embodiment, the survey technique allows a single (global) product survey to support multiple languages. For example, the product survey may be created or generated in English, and the use of accurate translations and/or transliterations into one or more target languages may allow

feedback about the product to be obtained in local language(s) and/or dialects in different countries or regions. For example, the product survey may be translated into any of 64 languages written from right to left (such as Arabic), and the survey technique may provide transliteration support for up to 14 languages. Note that the accuracy of the translations and/or transliterations may be ensured by allowing the product manager(s) to edit the machine translation and to modify it if the translated content does not make sense.

Furthermore, by analyzing the answers (such as by generating analytics) and translating the results back into English, the results can be assessed and compared across different languages and/or cultures by the product management (for example, by using a consolidated report of the results of the product survey in the different languages). In this way, the survey technique may allow a common product to be effectively provided to the different countries by the company.

The use of transliteration instructions also may allow the users of the product in the different countries to answer questions in the translated product survey using an English-language keyboard (and, more generally, a user interface in the original language). Thus, if there are users who want to answer questions in the survey using a target language that does not have its own keyboard (such as Hindi, Tamil, etc.), they can type such answers phonetically using an English-language keyboard.

During the survey-technique flow, the user may use a dashboard user interface to: define the product survey, publish the product survey so it can be conducted (for example, using email, text messaging, and/or another communication technique), collect the answers or responses, and analyze the answers to generate a consolidated report of the results. For example, the answers may include information, such as: question identifiers, answer identifiers, answer text, a user identifier and/or a user native or local language, and the consolidated report may include analytics based on this information.

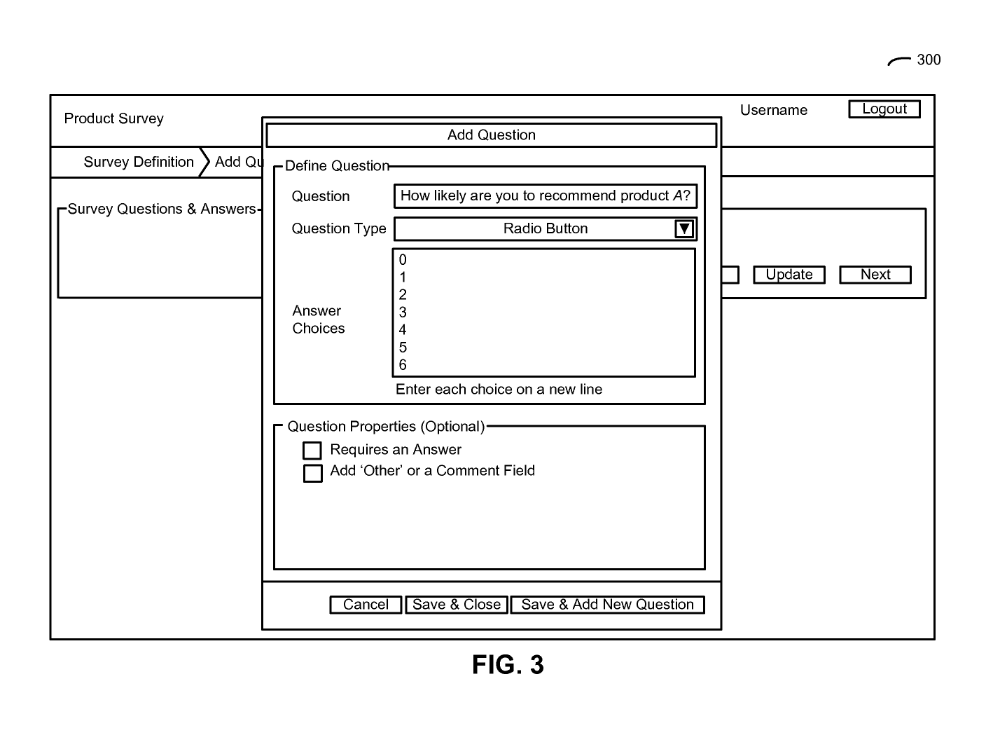

FIG. 3 presents a drawing of a user interface 300 that allows the user (such as a product manager) to define or specify a question in the product survey. While a number selection using radio buttons is illustrated in FIG. 3, in other embodiments the answer(s) to the question may be provided using: a check box, a text-entry box, and/or another user-interface object. After the product survey is translated to a target language, the user may provide the transliteration instruction(s). This is shown in FIG. 4, which presents a drawing of a user interface 400.

In an exemplary embodiment, a product manager may want to get feedback from customers of product A. The product manager may create a two-question product survey to determine a net promoter score for the customers, so that the customers can be segregated into: promoters of the product, detractors of the product, and individuals who are neutral or ‘passive’ about the product. For example, one of the questions in the product survey may be: How likely is it that you would recommend product A to a friend or colleague?

Then, the product manager may share the product survey with a global product manager to validate the product-survey questionnaire. This global product manager may decide that Spanish and Indian customers will appreciate a localized version of the product survey. The global product manager may use the survey technique to translate the product survey into Spanish and may determine that the machine translation is accurate and does not need to be corrected. Therefore, the global product manager may not make any changes to the translated product survey and may save it.

However, the global product manager may determine that the Hindi translation of the product survey is inaccurate at several locations. Therefore, the global product manager may manually correct errors in the translated product survey. These corrections may include transliteration instructions that specify a mapping from English keyboard characters to Hindi. Then, the global product manager may save this version of the translated product survey.

Using the dashboard, the global product manager may test the Spanish and Hindi versions of the product survey. In addition, the product manager may test the product survey and may share it with a developer of product A so it can be integrated into the application.

After the translated product survey has been integrated into product A, data on net promoter scores can be obtained in three languages: English, Spanish and Hindi. A small business customer of product A in New York may take the product survey in English. However, a small business customer of product A in New Delhi may take the product survey in Hindi.

As the product survey is being conducted, answers may be aggregated and analyzed into results, and these results may be translated into English so they can be reviewed. For example, a business analyst from the company that provides product A can log in to view the global product survey results, and can see the net promoter scores for customers of product A across different locations.

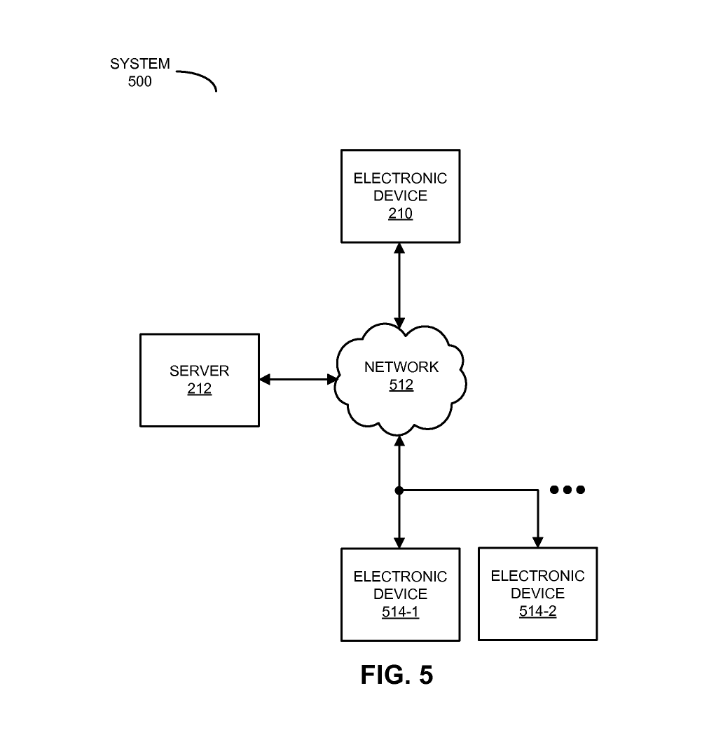

We now describe embodiments of a system and the computer system, and their use. FIG. 5 presents a block diagram illustrating a system 500 that can be used, in part, to perform operations in method 100 (FIGS. 1 and 2). In this system, during the survey technique a user of electronic device 210 may use a software product, such as a software application that is associated with a website. Server 212 may provide instructions for content on the website (such as web pages) to electronic device 210 via network 512, and this content may be rendered by a web browser on electronic device 210. However, at least a portion of the software application may be resident on and may execute on electronic device 210. Alternatively, the user may interact with one or more web pages that are provided by server 212 via network 512, and which are rendered by a web browser on electronic device 210. For example, at least a portion of the software application may be an application tool that is embedded in the web pages, and which executes in a virtual environment of the web browser. Thus, the application tool may be provided to the user via a client-server architecture. This software application may be a standalone application or a portion of another application that is resident on and which executes on electronic device 210 (such as a software application that is provided by server 212 or that is installed and which executes on electronic device 210).

During the survey technique, the user of electronic device 210 may specify the product survey in the original language. This information may be communicated to server 212 via network 512. In response to receiving these instructions, server 212 may generate the product survey.

Then, server 212 may translate the product survey into one or more target languages based on user input, and server 212 may identify and correct the errors in the translated product survey.

Next, via network 512, server 212 may provide the translated product survey. After receiving the translated product survey, electronic device 210 may present it to the user. For example, electronic device 210 may display the translated product survey on a display. In turn, the user may provide the transliteration instruction specifying the mapping of symbols in the original language to symbols in the target language. This information may be communicated to server 212 via network 512. In response to receiving the transliteration instruction, server 212 may modify the translated product survey.

Moreover, server 212 may conduct the product survey (operation 230). This may involve providing, via network 512, the translated product survey to electronic devices 514 of users of the product, and receiving, via the network 512, the answers from electronic devices 514 to questions in the translated product survey.

Server 212 may analyze the answers to determine the results, and may translate the results into the original language. Then, server 212 may provide the translated results to electronic device 210 using network 512. After receiving the translated results, electronic device 210 may present them to the user. For example, electronic device 210 may display the translated results in a graph on a display.

Note that information in system 500 may be stored at one or more locations in system 500 (i.e., locally or remotely). Moreover, because this data may be sensitive in nature, it may be encrypted. For example, stored data and/or data communicated via network 512 may be encrypted.

FIG. 6 presents a block diagram illustrating a computer system 600 that performs method 100 (FIGS. 1 and 2), such as server 212 (FIGS. 2 and 5). Computer system 600 includes one or more processing units or processors 610, a communication interface 612, a user interface 614, and one or more signal lines 622 coupling these components together. Note that the one or more processors 610 may support parallel processing and/or multi-threaded operation, the communication interface 612 may have a persistent communication connection, and the one or more signal lines 622 may constitute a communication bus. Moreover, the user interface 614 may include: a display 616, a keyboard 618, and/or a pointer 620, such as a mouse.

Memory 624 in computer system 600 may include volatile memory and/or non-volatile memory. More specifically, memory 624 may include: ROM, RAM, EPROM, EEPROM, flash memory, one or more smart cards, one or more magnetic disc storage devices, and/or one or more optical storage devices. Memory 624 may store an operating system 626 that includes procedures (or a set of instructions) for handling various basic system services for performing hardware-dependent tasks. Memory 624 may also store procedures (or a set of instructions) in a communication module 628. These communication procedures may be used for communicating with one or more computers and/or servers, including computers and/or servers that are remotely located with respect to computer system 600.

Memory 624 may also include multiple program modules (or sets of instructions), including: generating module 630 (or a set of instructions), survey module 632 (or a set of instructions), analysis module 634 (or a set of instructions), and/or encryption module 636 (or a set of instructions). Note that one or more of these program modules (or sets of instructions) may constitute a computer-program mechanism.

During the survey technique, computer system 600 may receive, via communication interface 612 and communication module 628, instructions 638 that specify product survey 640 (associated with product 654) in original language 642. In response to receiving these instructions, generating module 630 may generate product survey 640.

Then, generating module 630 may translate product survey 640 into one or more target language(s) 644, and generating module 630 may identify and correct one or more error(s) 648 in translated product survey 646.

Next, via communication module 628 and communication interface 612, generating module 630 may provide translated product survey 646 to the user. In response, computer system 600 may receive, via communication interface 612 and communication module 628, transliteration instructions 650 specifying a mapping 652 of symbols in original language 642 to symbols in at least one of the one or more target language(s) 644. In response to receiving transliteration instructions 650, generating module 630 may modify translated product survey 646.

Moreover, survey module 632 may conduct translated product survey 646. This may involve providing, via communication module 628 and communication interface 612, translated product survey 646 to users of product 654, and receiving, via communication interface 612 and communication module 628, answers 656 to questions in translated product survey 646.

Analysis module 634 may analyze answers 656 to determine results 658, and may translate results 658 into original language 642. Then, analysis module 634 may provide, via communication module 628 and communication interface 612, translated results 660 to the user.

Because information used in the survey technique may be sensitive in nature, in some embodiments at least some of the data stored in memory 624 and/or at least some of the data communicated using communication module 628 is encrypted or decrypted using encryption module 636.

Instructions in the various modules in memory 624 may be implemented in: a high-level procedural language, an object-oriented programming language, and/or in an assembly or machine language. Note that the programming language may be compiled or interpreted, e.g., configurable or configured, to be executed by the one or more processors 610.

Although computer system 600 is illustrated as having a number of discrete items, FIG. 6 is intended to be a functional description of the various features that may be present in computer system 600 rather than a structural schematic of the embodiments described herein. In some embodiments, some or all of the functionality of computer system 600 may be implemented in one or more application-specific integrated circuits (ASICs) and/or one or more digital signal processors (DSPs).

Computer system 600, as well as electronic devices, computers and servers in system 500 (FIG. 5), may include one of a variety of devices capable of manipulating computer-readable data or communicating such data between two or more computing systems over a network, including: a personal computer, a laptop computer, a tablet computer, a mainframe computer, a portable electronic device (such as a cellular telephone or PDA), a server, a point-of-sale terminal and/or a client computer (in a client-server architecture). Moreover, network 512 (FIG. 5) may include: the Internet, World Wide Web (WWW), an intranet, a cellular-telephone network, LAN, WAN, MAN, or a combination of networks, or other technology enabling communication between computing systems.

Electronic device 210 (FIGS. 2 and 5), server 212 (FIGS. 2 and 5), system 500 (FIG. 5), electronic devices 514 (FIG. 5) and/or computer system 600 may include fewer components or additional components. Moreover, two or more components may be combined into a single component, and/or a position of one or more components may be changed. In some embodiments, the functionality of electronic device 210 (FIGS. 2 and 5), server 212 (FIGS. 2 and 5), system 500 (FIG. 5), electronic devices 514 (FIG. 5) and/or computer system 600 may be implemented more in hardware and less in software, or less in hardware and more in software, as is known in the art.

While the preceding embodiments illustrated the survey technique using a product survey (i.e., a survey that collects information about a product from customers or users of the product), in other embodiments the survey technique may be used in conjunction with a wide variety of types of surveys, including questions about topics other than those about or related to a product. For example, the surveys may study consumer tastes or attitudes.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer-implemented method for conducting a product survey, the method comprising:
generating the product survey in an original language;
using the computer, translating the product survey into a target language;
identifying and correcting errors in the translated product survey;
providing the translated product survey to multiple users of the product;
receiving answers from the users to questions in the translated product survey;
analyzing the answers to determine results of the product survey in the target language;
translating the results into the original language; and
presenting the translated results.

2. The method of claim 1, wherein the method further comprises receiving instructions that specify the product survey in the original language, wherein generating the product survey is based on the instructions.

3. The method of claim 1, wherein the method further comprises receiving a selection that specifies the target language, wherein translating the product survey is based on the selection.

4. The method of claim 1, wherein the selection is one of a set of predefined languages.

5. The method of claim 1, wherein translating the product survey and translating the results involve a machine-translation technique.

6. The method of claim 1, wherein the errors are identified based on syntax and lexicography of the original language and the target language.

7. The method of claim 1, wherein identifying the errors involves receiving information identifying the errors.

8. The method of claim 1, wherein analyzing the answers involves aggregating the answers of the users.

9. The method of claim 1, wherein, after identifying and correcting the errors, the method further comprises receiving a transliteration instruction specifying a mapping of symbols in the original language to symbols in the target language.

10. The method of claim 9, wherein the transliteration instruction facilitates the users in providing the answers in the target language using a user interface based on the original language.

11. The method of claim 1, wherein, after translating the results, the method further comprises identifying and correcting errors in the translated results.

12. A computer-program product for use in conjunction with a computer system, the computer-program product comprising a non-transitory computer-readable storage medium and a computer-program mechanism embedded therein to conduct a product survey, the computer-program mechanism including:
instructions for generating the product survey in an original language;
instructions for translating the product survey into a target language;
instructions for identifying and instructions for correcting errors in the translated product survey;
instructions for providing the translated product survey to multiple users of the product;
instructions for receiving answers from the users to questions in the translated product survey;
instructions for analyzing the answers to determine results of the product survey in the target language;
instructions for translating the results into the original language; and
instructions for presenting the translated results.

13. The computer-program product of claim 12, wherein the computer-program mechanism further comprises instructions for receiving instructions that specify the product survey in the original language, wherein generating the product survey is based on the instructions.

14. The computer-program product of claim 12, wherein the computer-program mechanism further comprises instructions for receiving a selection that specifies the target language, wherein translating the product survey is based on the selection.

15. The computer-program product of claim 12, wherein translating the product survey and translating the results involve a machine-translation technique.

16. The computer-program product of claim 12, wherein the errors are identified based on syntax and lexicography of the original language and the target language.

17. The computer-program product of claim 12, wherein identifying the errors involves receiving information identifying the errors.

18. The computer-program product of claim 12, wherein, after the instructions for identifying and correcting the errors, the computer-program mechanism further comprises instructions for receiving a transliteration instruction specifying a mapping of symbols in the original language to symbols in the target language.

19. The computer-program product of claim 18, wherein the transliteration instruction facilitates the users in providing the answers in the target language using a user interface based on the original language.

20. A computer system, comprising:
a processor;
memory; and
a program module, wherein the program module is stored in the memory and configurable to be executed by the processor to conduct a product survey, the program module including:
instructions for generating the product survey in an original language;
instructions for translating the product survey into a target language;
instructions for identifying and instructions for correcting errors in the translated product survey;
instructions for providing the translated product survey to multiple users of the product;
instructions for receiving answers from the users to questions in the translated product survey;
instructions for analyzing the answers to determine results of the product survey in the target language;
instructions for translating the results into the original language; and
instructions for presenting the translated results.
